(19) United States
(12) Patent Application Publication
(10) Pub. No.: US 2025/0163242 A1
(43) Pub. Date: May 22, 2025

(54) POLYMERIC COMPOSITIONS CONTAINING A RANDOM COPOLYMER AND EFFECTS OF A GAMMA NUCLEATOR ON SUCH COMPOSITIONS

(71) Applicant: FINA TECHNOLOGY, INC., Houston, TX (US)

(72) Inventors: Michael MCLEOD, Houston, TX (US); Joachim AZZI, Houston, TX (US)

(21) Appl. No.: 18/516,496

(22) Filed: Nov. 21, 2023

(51) Int. Cl. C08K 5/098; C08J 5/18; C08K 5/13

(52) U.S. Cl. CPC C08K 5/098; C08J 5/18; C08K 5/13; C08J 2323/16

(57) ABSTRACT

Disclosed is a polymeric composition containing at least 98 wt. % of a random ethylene polypropylene copolymer, 0 wt. % to 1.0 wt. % of an acid neutralizer, and 0.005 wt. % to 1.0 wt. % of a gamma nucleator (a γ-nucleator). The random ethylene polypropylene copolymer can include 0.5 wt. % to 12 wt. % of ethylene units and 88 wt. % to 99.5 wt. % of propylene units based on the total weight of the copolymer. The polymeric composition can have a haze value of less than 60% (as measured in accordance with ASTM D-1003, at a thickness of about 40 mils) and a crystallization temperature of more than 100° C. as measured by Differential Scanning Calorimetry. Articles containing the polymeric composition are also disclosed.

### CROSS REFERENCE TO RELATED APPLICATIONS

None.

### BACKGROUND OF THE INVENTION

### A. Field of the Invention

The invention generally concerns polymeric compositions containing a random ethylene polypropylene copolymer and articles of manufacture made from the polymeric compositions, and more specifically to effects of a gamma nucleator on such polymeric compositions.

### B. Description of Related Art

Clarified random copolymers (RCPs) are ubiquitous in everyday life. They are used in products such as medical sharps containers, clear totes and bins, pipettes and other labware, food packaging containers, and a host of other applications. A sufficiently clear product with proficient impact performance could be utilized in these and other applications that are challenging to address except with specialty materials.

To develop RCPs with improved strength, current industrial practice is to blend elastomers and plastomers with clarified base resin. Common elastomers and plastomers for this purpose include VISTAMAXX™ (EXXONMOBIL®), ENGAGE™ (The Dow Chemical Company) and NOTIO® (Mitsui Plastics, Inc.) products. However, these blending agents are expensive and introduce additional manufacturing variables to be controlled, which can lead to reduced product quality.

Alternatively, incorporating higher amounts of ethylene into the RCP backbone has been proposed to reduce crystallinity and improve toughness, but this is likely to decrease product clarity because catalyst productivity is decreased at operating rates required to incorporate more ethylene. This, in turn, leads to more acidic catalyst residues that attack and consume commercial clarifiers, rendering them ineffective. Additionally, as more ethylene is incorporated, undesired byproducts such as low molecular weight amorphous species or low molecular weight polyethylene waxes are produced. These species differ sufficiently from the base polymer such that they phase separate and interfere with light transmission. For example, species unable to disperse in the polymer can migrate to the surface of molded parts and create a heterophasic structure that scatters light and creates an excessively diverse population of molecular architectures that generates varying indices of refraction within a molded part.

### SUMMARY OF THE INVENTION

A discovery has been made that provides a solution to at least one or more of the aforementioned problems. In one aspect, the solution can include providing a composition having at least 98 wt. % of a random ethylene polypropylene copolymer, an acid neutralizer (according to some aspects), and γ-nucleator (also referred to herein as a “gamma nucleator”). It has been discovered that this combination can provide for ethylene polypropylene copolymer-based compositions having relatively low nucleator content without sacrificing clarity and reducing lot-to-lot peak crystallization temperature (Tc) variation. As illustrated in a non-limiting manner in the examples of this application, polymeric compositions of the present invention containing an ethylene polypropylene copolymer and a γ-nucleator can have a haze value lower than 60%, as measured in accordance with ASTM D-1003, at a thickness of about 40 mils, and a crystallization temperature greater than 100° C., as measured by Differential Scanning Calorimetry. These clarity and crystallization temperature properties can be achieved by using relatively low amounts of a γ-nucleator (e.g., 0.005 wt. % to 1.0 wt. % or less than 950 parts per million (ppm), less than 500 ppm, or less than 250 ppm of the nucleator in the compositions of the invention). Using lower amounts of nucleators in the compositions while reducing lot-to-lot peak crystallization temperature (Tc) variation (which can be important from a processing viewpoint, such as by maintaining consistent cycle type in injection molding applications) can provide cost and/or production efficiencies for the compositions of the present invention.

One aspect of the present invention is directed to a polymeric composition. The polymeric composition can contain a random ethylene polypropylene copolymer, an acid neutralizer, and a gamma nucleator. In some aspects, the polymeric composition can contain at least 98 wt. % (or 98.1, 98.2, 98.3, 98.4, 98.5, 98.6, 98.7. 98.8, 98.9, 99.0, 99.1, 99.2, 99.3, 99.4, 99.5, 99.6, 99.7, or 99.8 wt. % or any range therein) of the random ethylene polypropylene copolymer, 0 wt. % to 1.0 wt. % (or 0.02, 0.03, 0.04, 0.05, 0.06, 0.07, 0.08, 0.09, 0.1, 0.2, 0.3, 0.4, 0.5, 0.6, 0.7, 0.8, 0.9 wt. % or any range therein) of the acid neutralizer, and 0.005 wt. % to 1.0 wt. % (or 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 wt. % or any range therein) of the gamma nucleator, or any combinations thereof.

The polymeric composition can have a haze lower than the haze of random ethylene polypropylene copolymer, when measured under similar conditions. In some aspects, the polymeric composition has a haze value of less than 60%, as measured in accordance with ASTM D-1003, at a thickness of about 40 mil.

The polymeric composition can have a crystallization temperature (Tc) higher than the crystallization temperature of random ethylene polypropylene copolymer, when measured under similar conditions. In some aspects, the polymeric composition has a crystallization temperature of more than 100° C. as measured by Differential Scanning Calorimetry.

The random ethylene polypropylene copolymer can have relatively high ethylene content. In some aspects, the random ethylene polypropylene copolymer comprises 0.5 wt. % to 12 wt. % (or 1, 2, 3, 4, 5, 6, 7, 8, 9, 10, or 11 wt. % or any range therein) of ethylene units, and 88 wt. % to 99.5 wt. % (or 89, 90, 91, 92, 93, 94, 95, 96, 97, 98, or 99 wt. % or any range therein) of propylene units, based on the total weight of the copolymer. In particular aspects, the random ethylene polypropylene copolymer comprises 1.5 wt. % to 5 wt. % (or 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, or 4.9 wt. % or any range therein) of ethylene units and 95 wt. % to 98.5 wt. % (or 95.1, 95.2, 95.3, 95.4, 95.5, 95.6, 95.7, 95.8, 95.9, 96, 96.1, 96.2, 96.3, 96.4, 96.5, 96.6, 96.7, 96.8, 96.9, 97, 97.1, 97.2, 97.3, 97.4, 97.5, 97.6, 97.7, 97.8, 97.9, 98, 98.1, 98.2, 98.3, or 98.4 wt. % or any range therein) of propylene units based on the total weight of the copolymer. In some aspects, the random ethylene polypropylene copolymer can be a random-heterophasic copolymer. In some aspects, the random ethylene polypropylene copolymer can be a Ziegler-Natta random ethylene polypropylene copolymer (also referred to herein as a “ZN RCP”). The Ziegler-Natta random ethylene polypropylene copolymer can be a random ethylene polypropylene copolymer prepared using a Ziegler-Natta catalyst. In some aspects, the random ethylene polypropylene copolymer is a metallocene random ethylene polypropylene copolymer (also referred to herein as a “mRCP”). The metallocene random ethylene polypropylene copolymer can be a random ethylene polypropylene copolymer prepared using a metallocene catalyst.

The acid neutralizer (optional, according to some aspects, such as for some metallocene random ethylene polypropylene copolymers) can be a metal stearate. In some aspects, metal stearate can be calcium stearate, zinc stearate, potassium stearate, sodium stearate, lithium stearate, aluminum stearate, magnesium stearate, manganese stearate, cobalt stearate, cerium stearate, copper stearate, ferric stearate, nickel stearate, or any combinations thereof. In particular aspects, the metal stearate is calcium stearate.

In some aspects, the polymeric composition includes less than 950 parts per million (ppm) of the gamma nucleator. In some aspects, the polymeric composition includes less than 500 parts per million (ppm) of the gamma nucleator. In some aspects, the polymeric composition includes less than 250 parts per million (ppm) of the gamma nucleator. In some particular aspects, the gamma nucleator can be disodium; (1R,2R,3S,4S)-bicyclo[2.2.1]heptane-2,3-dicarboxylate.

In certain aspects, the polymeric composition further comprises one or more additives selected from an antioxidant, a stabilizer, a peroxide, a slip agent, an antistatic/release agent, a flame retardant (FR) additive, a light stabilizer, a flow modifier, a process aid, an anti-block agent, an optical brightener, or any combinations thereof. In some particular aspects, the one or more additives can be an antioxidant, an antistatic/release agent, and a stabilizer. In some aspects, the antioxidant can be a hindered phenol-based antioxidant (e.g., pentaerythritol tetrakis(3-(3,5-di-tert-butyl-4-hydroxyphenyl)propionate [IRGANOX® 1010, BASF]). In some aspects, the antistatic/release agent can be a glycerol ester (e.g., a glycerol monostearate, [PATIONIC® 1052K, Corbion]). In some aspects, the stabilizer can be a hydrolytically stable phosphite-based stabilizer (e.g., tris(2,4-di-tert.-butylphenyl)phosphite) [IRGAFOS® 168, BASF]).

The polymeric composition described herein can be an extruded, a blow-molded, an injection-molded, rotational molded, compression molded, and/or thermoformed composition. In certain aspects, the composition can be in form of a sheet and/or film. Certain aspects are directed to an article of manufacture containing a polymeric composition described herein. In some aspects, the article of manufacture can be transparent. In some aspects, the article of manufacture can be a medical sharps container, tote, bins, pipettes, laboratory ware, food packaging container, food storage container, cooking utensil, plate, cup, cavity tray, drinking cup, measuring cup, strainer, turkey baster, non-food storage container, filing cabinet, cabinet drawer, general storage device, organizer, sweater box, rigid packaging, deli container, deli container lid, dairy container, dairy container lid, personal care product bottle and jar, furniture, furniture component, building material and building container components, film, coating, fiber, bag, adhesive, yarn and fabric blister, or clamshell.

Other aspects or embodiments of the invention are discussed throughout this application. Any aspect or embodiment discussed with respect to one aspect of the invention applies to other aspects or embodiments of the invention as well and vice versa. Each aspect or embodiment described herein is understood to be aspects or embodiments of the invention that are applicable to other aspects of the invention. It is contemplated that any aspect or embodiment discussed herein can be combined with other aspects or embodiments discussed herein and/or implemented with respect to any method or composition of the invention, and vice versa. Furthermore, compositions and systems of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, alternatively within 5%, alternatively within 1%, and alternatively within 0.5%.

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The terms “ppm” refer to parts per million by weight of a component, based on the total weight, that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification include any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, X, Y, and/or Z can include: X alone, Y alone, Z alone, a combination of X and Y, a combination of X and Z, a combination of Y and Z, or a combination of X, Y, and Z.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process and systems of the present invention can “comprise,” “consist essentially of,” or “consist of” particular ingredients, components, compositions, steps, etc., disclosed throughout the specification. With respect to the transitional phrase “consisting essentially of,” in one non-limiting aspect, a basic and novel characteristic of the compositions and processes of the present invention are polymeric compositions containing a random ethylene polypropylene copolymer, an (optional) acid neutralizer, and a gamma nucleator (a γ-nucleator). The polymeric compositions can have (1) a haze value lower than the random ethylene polypropylene copolymer when measured under similar conditions, and/or (2) a crystallization temperature higher than the random ethylene polypropylene copolymer when measured under similar conditions.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

The following drawings form part of the present specification and are included to further demonstrate certain aspects of the present disclosure. The invention may be better understood by reference to one or more of these drawings in combination with the detailed description of specific aspects presented below.

FIG. 1 is a graphical representation of flexural modulus values associated with an exemplary metallocene RCP and an exemplary ZN RCP;

FIG. 2 is a graphical representation of haze values (for a thickness of about 40 mils) associated with an exemplary metallocene RCP and an exemplary ZN RCP;

FIG. 3 is a graphical representation of gloss values associated with an exemplary metallocene RCP and an exemplary ZN RCP;

FIG. 4 is a graphical representation of crystallization temperature values associated with an exemplary metallocene RCP and an exemplary ZN RCP;

FIG. 5 is a graphical representation of shrinkage isotropy values associated with an exemplary metallocene RCP and an exemplary ZN RCP; and

FIG. 6 is a graphical representation of shrinkage isotropy values versus crystallization temperature values associated with an exemplary metallocene RCP and an exemplary ZN RCP.

### DETAILED DESCRIPTION OF THE INVENTION

A polymeric composition of the present invention can include at least 98 wt. % of a random ethylene polypropylene copolymer, wherein the random ethylene polypropylene copolymer comprises 0.5 wt. % to 12 wt. % of ethylene units and 88 wt. % to 99.5 wt. % of propylene units based on the total weight of the copolymer, 0 wt. % to 1.0 wt. % of an acid neutralizer, and 0.005 wt. % to 1.0 wt. % of a gamma nucleator (a γ-nucleator). The composition can have a haze value of less than 60% (as measured in accordance with ASTM D-1003, at a thickness of about 40 mils) and a crystallization temperature of more than 100° C. (as measured by Differential Scanning Calorimetry). These features can be obtained while using low amounts of the gamma nucleator, which can be advantageous in that it can reduce the costs of producing the compositions while reducing lot-to-lot peak crystallization temperature (Tc) variation (which can be important from a processing viewpoint, such as by maintaining consistent cycle type in injection molding applications).

These and other non-limiting aspects of the present invention are discussed in further detail in the following sections.

### A. Polymeric Compositions

The polymeric compositions of the present invention can contain at least 98 wt. %, such as 98 wt. % to 99.8 wt. %, or at least any one of, at most any one of, equal to any one of, or between any two of 98 wt. %, 98.01 wt. %, 98.02 wt. %, 98.03 wt. %, 98.04 wt. %, 98.05 wt. %, 98.06 wt. %, 98.07 wt. %, 98.08 wt. %, 98.09 wt. %, 98.1 wt. %, 98.11 wt. %, 98.12 wt. %, 98.13 wt. %, 98.14 wt. %, 98.15 wt. %, 98.16 wt. %, 98.17 wt. %, 98.18 wt. %, 98.19 wt. %, 98.2 wt. %, 98.21 wt. %, 98.22 wt. %, 98.23 wt. %, 98.24 wt. %, 98.25 wt. %, 98.26 wt. %, 98.27 wt. %, 98.28 wt. %, 98.29 wt. %, 98.3 wt. %, 98.31 wt. %, 98.32 wt. %, 98.33 wt. %, 98.34 wt. %, 98.35 wt. %, 98.36 wt. %, 98.37 wt. %, 98.38 wt. %, 98.39 wt. %, 98.4 wt. %, 98.41 wt. %, 98.42 wt. %, 98.43 wt. %, 98.44 wt. %, 98.45 wt. %, 98.46 wt. %, 98.47 wt. %, 98.48 wt. %, 98.49 wt. %, 98.5 wt. %, 98.51 wt. %, 98.52 wt. %, 98.53 wt. %, 98.54 wt. %, 98.55 wt. %, 98.56 wt. %, 98.57 wt. %, 98.58 wt. %, 98.59 wt. %, 98.6 wt. %, 98.61 wt. %, 98.62 wt. %, 98.63 wt. %, 98.64 wt. %, 98.65 wt. %, 98.66 wt. %, 98.67 wt. %, 98.68 wt. %, 98.69 wt. %, 98.7 wt. %, 98.71 wt. %, 98.72 wt. %, 98.73 wt. %, 98.74 wt. %, 98.75 wt. %, 98.76 wt. %, 98.77 wt. %, 98.78 wt. %, 98.79 wt. %, 98.8 wt. %, 98.81 wt. %, 98.82 wt. %, 98.83 wt. %, 98.84 wt. %, 98.85 wt. %, 98.86 wt. %, 98.87 wt. %, 98.88 wt. %, 98.89 wt. %, 98.9 wt. %, 98.91 wt. %, 98.92 wt. %, 98.93 wt. %, 98.94 wt. %, 98.95 wt. %, 98.96 wt. %, 98.97 wt. %, 98.98 wt. %, 98.99 wt. %, 99 wt. %, 99.01 wt. %, 99.02 wt. %, 99.03 wt. %, 99.04 wt. %, 99.05 wt. %, 99.06 wt. %, 99.07 wt. %, 99.08 wt. %, 99.09 wt. %, 99.1 wt. %, 99.11 wt. %, 99.12 wt. %, 99.13 wt. %, 99.14 wt. %, 99.15 wt. %, 99.16 wt. %, 99.17 wt. %, 99.18 wt. %, 99.19 wt. %, 99.2 wt. %, 99.21 wt. %, 99.22 wt. %, 99.23 wt. %, 99.24 wt. %, 99.25 wt. %, 99.26 wt. %, 99.27 wt. %, 99.28 wt. %, 99.29 wt. %, 99.3 wt. %, 99.31 wt. %, 99.32 wt. %, 99.33 wt. %, 99.34 wt. %, 99.35 wt. %, 99.36 wt. %, 99.37 wt. %, 99.38 wt. %, 99.39 wt. %, 99.4 wt. %, 99.41 wt. %, 99.42 wt. %, 99.43 wt. %, 99.44 wt. %, 99.45 wt. %, 99.46 wt. %, 99.47 wt. %, 99.48 wt. %, 99.49 wt. %, 99.5 wt. %, 99.51 wt. %, 99.52 wt. %, 99.53 wt. %, 99.54 wt. %, 99.55 wt. %, 99.56 wt. %, 99.57 wt. %, 99.58 wt. %, 99.59 wt. %, 99.6 wt. %, 99.61 wt. %, 99.62 wt. %, 99.63 wt. %, 99.64 wt. %, 99.65 wt. %, 99.66 wt. %, 99.67 wt. %, 99.68 wt. %, 99.69 wt. %, 99.7 wt. %, 99.71 wt. %, 99.72 wt. %, 99.73 wt. %, 99.74 wt. %, 99.75 wt. %, 99.76 wt. %, 99.77 wt. %, 99.78 wt. %, 99.79 wt. %, and 99.8 wt. % of a random ethylene polypropylene copolymer.

In some aspects, the polymeric compositions of the present invention can further contain at least 0.01 wt. %, such as 0.01 wt. % to 1.0 wt. %, or at least any one of, at most any one of, equal to any one of, or between any two of 0.01 wt. % to 1.0 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of an acid neutralizer. In other aspects (e.g., such as for some metallocene RCPs), the polymeric compositions of the present invention can be substantially free of an acid neutralizer.

The polymeric compositions of the present invention can further contain at least 0.005 wt. %, such as 0.005 wt. % to 1.0 wt. %, or at least any one of, at most any one of, equal to any one of, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of a gamma nucleator (a γ-nucleator).

In some aspects, the polymeric compositions of the present invention can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of an antioxidant.

In some aspects, the polymeric compositions of the present invention can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of an antistatic/release agent.

In some aspects, the polymeric compositions of the present invention can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of a stabilizer.

### 1. Random Ethylene Polypropylene Copolymer

The random ethylene polypropylene copolymer that can be used in the polymeric compositions of the present invention can include at least 0.5 wt. %, such as 0.5 wt. % to 12 wt. %, or at least any one of, at most any one of, equal to any one of, or between any two of 0.5 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 3.1 wt. %, 3.2 wt. %, 3.3 wt. %, 3.4 wt. %, 3.5 wt. %, 3.6 wt. %, 3.7 wt. %, 3.8 wt. %, 3.9 wt. %, 4 wt. %, 4.1 wt. %, 4.2 wt. %, 4.3 wt. %, 4.4 wt. %, 4.5 wt. %, 4.6 wt. %, 4.7 wt. %, 4.8 wt. %, 4.9 wt. %, 5 wt. %, 5.1 wt. %, 5.2 wt. %, 5.3 wt. %, 5.4 wt. %, 5.5 wt. %, 5.6 wt. %, 5.7 wt. %, 5.8 wt. %, 5.9 wt. %, 6 wt. %, 6.1 wt. %, 6.2 wt. %, 6.3 wt. %, 6.4 wt. %, 6.5 wt. %, 6.6 wt. %, 6.7 wt. %, 6.8 wt. %, 6.9 wt. %, 7 wt. %, 7.1 wt. %, 7.2 wt. %, 7.3 wt. %, 7.4 wt. %, 7.5 wt. %, 7.6 wt. %, 7.7 wt. %, 7.8 wt. %, 7.9 wt. %, 8 wt. %, 8.1 wt. %, 8.2 wt. %, 8.3 wt. %, 8.4 wt. %, 8.5 wt. %, 8.6 wt. %, 8.7 wt. %, 8.8 wt. %, 8.9 wt. %, 9 wt. %, 9.1 wt. %, 9.2 wt. %, 9.3 wt. %, 9.4 wt. %, 9.5 wt. %, 9.6 wt. %, 9.7 wt. %, 9.8 wt. %, 9.9 wt. %, 10 wt. %, 10.1 wt. %, 10.2 wt. %, 10.3 wt. %, 10.4 wt. %, 10.5 wt. %, 10.6 wt. %, 10.7 wt. %, 10.8 wt. %, 10.9 wt. %, 11 wt. %, 11.1 wt. %, 11.2 wt. %, 11.3 wt. %, 11.4 wt. %, 11.5 wt. %, 11.6 wt. %, 11.7 wt. %, 11.8 wt. %, 11.9 wt. %, and 12 wt. % ethylene units, and at least 88 wt. %, such as 88 wt. % to 99.5 wt. %, or least any one of, at most any one of, equal to any one of, or between any two of 88 wt. %, 88.1 wt. %, 88.2 wt. %, 88.3 wt. %, 88.4 wt. %, 88.5 wt. %, 88.6 wt. %, 88.7 wt. %, 88.8 wt. %, 88.9 wt. %, 89 wt. %, 89.1 wt. %, 89.2 wt. %, 89.3 wt. %, 89.4 wt. %, 89.5 wt. %, 89.6 wt. %, 89.7 wt. %, 89.8 wt. %, 89.9 wt. %, 90 wt. %, 90.1 wt. %, 90.2 wt. %, 90.3 wt. %, 90.4 wt. %, 90.5 wt. %, 90.6 wt. %, 90.7 wt. %, 90.8 wt. %, 90.9 wt. %, 91 wt. %, 91.1 wt. %, 91.2 wt. %, 91.3 wt. %, 91.4 wt. %, 91.5 wt. %, 91.6 wt. %, 91.7 wt. %, 91.8 wt. %, 91.9 wt. %, 92 wt. %, 92.1 wt. %, 92.2 wt. %, 92.3 wt. %, 92.4 wt. %, 92.5 wt. %, 92.6 wt. %, 92.7 wt. %, 92.8 wt. %, 92.9 wt. %, 93 wt. %, 93.1 wt. %, 93.2 wt. %, 93.3 wt. %, 93.4 wt. %, 93.5 wt. %, 93.6 wt. %, 93.7 wt. %, 93.8 wt. %, 93.9 wt. %, 94 wt. %, 94.1 wt. %, 94.2 wt. %, 94.3 wt. %, 94.4 wt. %, 94.5 wt. %, 94.6 wt. %, 94.7 wt. %, 94.8 wt. %, 94.9 wt. %, 95 wt. %, 95.1 wt. %, 95.2 wt. %, 95.3 wt. %, 95.4 wt. %, 95.5 wt. %, 95.6 wt. %, 95.7 wt. %, 95.8 wt. %, 95.9 wt. %, 96 wt. %, 96.1 wt. %, 96.2 wt. %, 96.3 wt. %, 96.4 wt. %, 96.5 wt. %, 96.6 wt. %, 96.7 wt. %, 96.8 wt. %, 96.9 wt. %, 97 wt. %, 97.1 wt. %, 97.2 wt. %, 97.3 wt. %, 97.4 wt. %, 97.5 wt. %, 97.6 wt. %, 97.7 wt. %, 97.8 wt. %, 97.9 wt. %, %, 98 wt. %, 98.1 wt. %, 98.2 wt. %, 98.3 wt. %, 98.4 wt. %, 98.5 wt. %, 98.6 wt. %, 98.7 wt. %, 98.8 wt. %, 98.9 wt. %, 99 wt. %, 99.1 wt. %, 99.2 wt. %, 99.3 wt. %, 99.4 wt. %, and 99.5 wt. % propylene units, based on the total weight of the copolymer.

According to some aspects, the random ethylene polypropylene copolymer that can be used in the polymeric compositions of the present invention can include at least 1.5 wt. %, such as 1.5 wt. % to 5 wt. %, or at least any one of, at most any one of, equal to any one of, or between any two of 1.5 wt. %, 1.6 wt. %, 1.7 wt. %, 1.8 wt. %, 1.9 wt. %, 2 wt. %, 2.1 wt. %, 2.2 wt. %, 2.3 wt. %, 2.4 wt. %, 2.5 wt. %, 2.6 wt. %, 2.7 wt. %, 2.8 wt. %, 2.9 wt. %, 3 wt. %, 3.1 wt. %, 3.2 wt. %, 3.3 wt. %, 3.4 wt. %, 3.5 wt. %, 3.6 wt. %, 3.7 wt. %, 3.8 wt. %, 3.9 wt. %, 4 wt. %, 4.1 wt. %, 4.2 wt. %, 4.3 wt. %, 4.4 wt. %, 4.5 wt. %, 4.6 wt. %, 4.7 wt. %, 4.8 wt. %, 4.9 wt. %, and 5 wt. % ethylene units, and at least 95 wt. %, such as 95 wt. % to 98.5 wt. %, or least any one of, at most any one of, equal to any one of, or between any two of 95 wt. %, 95.1 wt. %, 95.2 wt. %, 95.3 wt. %, 95.4 wt. %, 95.5 wt. %, 95.6 wt. %, 95.7 wt. %, 95.8 wt. %, 95.9 wt. %, 96 wt. %, 96.1 wt. %, 96.2 wt. %, 96.3 wt. %, 96.4 wt. %, 96.5 wt. %, 96.6 wt. %, 96.7 wt. %, 96.8 wt. %, 96.9 wt. %, 97 wt. %, 97.1 wt. %, 97.2 wt. %, 97.3 wt. %, 97.4 wt. %, 97.5 wt. %, 97.6 wt. %, 97.7 wt. %, 97.8 wt. %, 97.9 wt. %, 98 wt. %, 98.1 wt. %, 98.2 wt. %, 98.3 wt. %, 98.4 wt. %, and 98.5 wt. % propylene units, based on the total weight of the copolymer.

The copolymer can be prepared via conventional polymerization processes such as those known in the art. Examples of such polymerization processes include slurry, liquid-bulk, and gas-phase polymerizations. In slurry polymerization processes, polymerization occurs in the presence of a solvent, e.g. hexane, within a loop or continuous stirred tank reactor. Polymerization may also be carried out by bulk-phase polymerization, where liquid propylene and ethylene serve as both monomer and diluent. In a typical bulk process, one or more loop reactors are generally employed. In other aspects, the copolymer may be produced by gas phase polymerization of propylene and ethylene, which is typically carried out in a fluidized bed reactor. Polymer fluff or powder produced from the polymerization reaction can be removed from the reactor and can then be processed via conventional techniques, such as by extrusion, to produce the desired copolymer pellets.

The amount of ethylene monomer used during polymerization of the copolymer is desirably in proportion to the desired final ethylene content of the target propylene copolymer. In some embodiments the ethylene content during polymerization can range from 0.5 wt. % to 12 wt. %, based on the total weight of the monomers, e.g. ethylene and propylene, present during polymerization. In some aspects, the copolymer can be prepared using metallocene catalysts or Ziegler-Natta catalysts.

In some particular aspects, the random ethylene polypropylene copolymer can be a metallocene random ethylene polypropylene copolymer (also referred to herein as an “mRCP”) having a MFR of about 12 g/10 min at 230° C., 2.16 kg, as measured in accordance with ASTM D-1238.

In some particular aspects of the present disclosure, the random ethylene polypropylene copolymer can be a Ziegler-Natta random ethylene polypropylene copolymer (also referred to herein as a “ZN RCP”) having a MFR of about 8 g/10 min at 230° C., 2.16 kg, as measured in accordance with ASTM D-1238.

### 2. Acid Neutralizer

In some aspects, the polymeric compositions of the present invention can include an acid neutralizer. In some aspects, the acid neutralizer can be a metal stearate, metallic oxides, hydrotalcite, or any combination thereof. In some aspects, metal stearate can be calcium stearate, zinc stearate, potassium stearate, sodium stearate, lithium stearate, aluminum stearate, magnesium stearate, manganese stearate, cobalt stearate, cerium stearate, copper stearate, ferric stearate, nickel stearate, a M-series catalyst neutralizer available from Mitsui Plastics, Inc. (e.g., M7L neutralizer), or any combinations thereof. The M-Series catalyst neutralizer can include a metal stearate/metal oxide mixture of calcium stearate, zinc stearate, and zinc oxide (e.g., M3L, M7L, M37L, M70P, M737LP, or any combination thereof, each of which is commercially available neutralizer from Mitsui Plastics, Inc. (White Plains, New York)). In some particular aspects, the metal stearate is calcium stearate. In other aspects (e.g., such as for some metallocene RCPs), the polymeric compositions of the present invention can be substantially free of an acid neutralizer.

In certain aspects, the polymeric compositions of the present invention can contain at least 0.01 wt. %, such as 0.01 wt. % to 1.0 wt. %, or at least any one of, at most any one of, equal to any one of, or between any two of 0.01 wt. % to 1.0 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of a metal stearate, such as calcium stearate.

Certain nucleating agents, e.g., a gamma-nucleator such as Hyperform® HPN® 68L from Milliken & Company, may be chemically sensitive to acidic species. Inadequate neutralization can cause the nucleating agent to be consumed via hydrolysis, thereby rendering it ineffective for acting as a nucleator to yield fine crystallites smaller than the wavelength of light. Thus, in some aspects, inclusion of an acid neutralizer in the polymeric composition can reduce the haze value of the composition. Without wishing to be bound by theory, in some aspects, inclusion of an acid neutralizer in the polymeric composition can neutralize acidic species, thereby reducing the haze value of the composition and protecting processing equipment (e.g., metal mold surfaces). In other aspects (e.g., such as for some metallocene RCPs), the polymeric compositions of the present invention can be substantially free of an acid neutralizer.

### 3. Gamma Nucleator

The polymeric compositions of the present invention include a gamma nucleator (also referred to as a nucleating agent). In certain aspects, the polymeric compositions can contain at least 0.005 wt. %, such as 0.005 wt. % to 1.0 wt. %, or at least any one of, at most any one of, equal to any one of, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of a gamma nucleator. Gamma nucleators predominantly encourage the formation of gamma form crystals. Gamma nucleators can include nano clay materials and/or montmorillonoid clay materials. Nano clays can include nanoparticles of layered mineral silicates. Examples of types of nano clays include montmorillonite, bentonite, kaolinite, hectorite and halloysite. In some embodiments, the clay is a montmorillonite, which includes layers of aluminosilicate. In some embodiments the clay may also include magnesium. In some embodiments, the clay may be an organic modified montmorillonoid clay. In some embodiments, at least some of the native sodium and/or calcium ions in the montmorillonoid clay may be replaced with a variety of different ammonium ions. Illustrative examples of suitable organic modifiers include but are not limited to bis(2-hydroxy-ethyl)methyl rapeseed ammonium, bis(2-hydroxy-ethyl)methyl coco ammonium, bis(2-hydroxy-ethyl)methyl tallow ammonium, trimethyl tallow quaternary ammonium, trimethyl tallow quaternary ammonium, trimethyl hydrogenated-tallow ammonium, triethyl hydrogenated-tallow ammonium, dimethyl hydrogenated-tallow ammonium, methyl bis(hydrogenated-tallow)ammonium and dimethyl bis(hydrogenated-tallow)ammonium.

In a particularly preferred embodiment, the gamma nucleator can be Hyperform® HPN® 68L from Milliken & Company (Spartanburg, South Carolina, USA). Hyperform® HPN® 68L includes disodium; (1R,2R,3S,4S)-bicyclo[2.2.1]heptane-2,3-dicarboxylate. In certain aspects, Hyperform® HPN® 68L can include 80 percent Bicylco[2.2.1]heptane-2,3-dicarboxylate and 20 percent of an anti-caking agent (e.g., Sylobloc® 250, which is a blend of amorphous silicon dioxide and (Z)-13-docosenamide. In some aspects, the polymeric compositions of the present invention can contain less than 950 parts per million (ppm), such as 950 ppm to 500 ppm, or at most or equal to any one of 500 ppm, 510 ppm, 520 ppm, 530 ppm, 540 ppm, 550 ppm, 560 ppm, 570 ppm, 580 ppm, 590 ppm, 600 ppm, 610 ppm, 620 ppm, 630 ppm, 640 ppm, 650 ppm, 660 ppm, 670 ppm, 680 ppm, 690 ppm, 700 ppm, 710 ppm, 720 ppm, 730 ppm, 740 ppm, 750 ppm, 760 ppm, 770 ppm, 780 ppm, 790 ppm, 800 ppm, 810 ppm, 820 ppm, 830 ppm, 840 ppm, 850 ppm, 860 ppm, 870 ppm, 880 ppm, 890 ppm, 900 ppm, 910 ppm, 920 ppm, 930 ppm, 940 ppm, and 950 ppm of a gamma-nucleator (e.g., Hyperform® HPN® 68L, Milliken & Company).

In some aspects, the polymeric compositions of the present invention can contain less than 500 ppm, such as 500 ppm to 250 ppm, or at most or equal to any one of 250 ppm, 260 ppm, 270 ppm, 280 ppm, 290 ppm, 300 ppm, 310 ppm, 320 ppm, 330 ppm, 340 ppm, 350 ppm, 360 ppm, 370 ppm, 380 ppm, 390 ppm, 400 ppm, 410 ppm, 420 ppm, 430 ppm, 440 ppm, 450 ppm, 460 ppm, 470 ppm, 480 ppm, 490 ppm, and 500 ppm of a gamma-nucleator (e.g., Hyperform® HPN® 68L, Milliken & Company).

In some aspects, the polymeric compositions of the present invention can contain less than 250 ppm, such as 250 ppm to 50 ppm, or at most or equal to any one of 50 ppm, 60 ppm, 70 ppm, 75 ppm, 80 ppm, 90 ppm, 100 ppm, 110 ppm, 120 ppm, 130 ppm, 140 ppm, 150 ppm, 160 ppm, 170 ppm, 180 ppm, 190 ppm, 200 ppm, 210 ppm, 220 ppm, 230 ppm, 240 ppm, and 250 ppm of a gamma-nucleator (e.g., Hyperform® HPN® 68L, Milliken & Company). In some particular aspects, the polymeric compositions of the present invention can contain 50 ppm to 200 ppm of a gamma-nucleator (e.g., Hyperform® HPN® 68L, Milliken & Company).

### 4. Additives

In some aspects, the polymeric compositions of the present invention can further contain one or more additives selected from antioxidants, stabilizers, peroxides, slip agents, antistatic/release agents, FR additives, light stabilizers, flow modifiers, process aids, anti-block agents and/or optical brighteners. In some aspects, the polymeric compositions of the present invention further include an antioxidant, an antistatic/release agent, a stabilizer, or any combinations thereof.

In some aspects, the antioxidant can be a hindered phenol-based antioxidant. In some aspects, the hindered phenol-based antioxidant can be pentaerythritol tetrakis[3-[3,5-di-tert-butyl-4-hydroxyphenyl]propionate, octadecyl-3-[3,5-di-tert-butyl-4-hydroxyphenyl]propionate], pentaerythritol tetrakis[3-[3,5-di-tert-butyl-4-hydroxyphenyl]propionate, or 1,3,5-tris(3,5-di-tert-butyl-4-hydroxybenzyl)-1,3,5-triazine-2,4,6(1H,3H,5H)-trione, or any combinations thereof. In some particular aspects, the antioxidant can be pentaerythritol tetrakis[3-[3,5-di-tert-butyl-4-hydroxyphenyl]propionate (IRGANOX® 1010, BASF). In some aspects, the antistatic/release agent can be a glycerol ester. In some particular aspects, the antistatic/release agent can be a glycerol monostearate (PATIONIC® 1052K, Corbion). In some aspects, the stabilizer can be a phosphite-containing stabilizer, such as a hydrolytically stable phosphite-based stabilizer. In some particular aspects, the stabilizer can be tris(2,4-di-tert.-butylphenyl)phosphite (IRGAFOS® 168, BASF).

In some aspects, the polymeric compositions can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of the antioxidant (e.g., IRGANOX® 1010, BASF).

In some aspects, the polymeric compositions can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of the antistatic/release agent (e.g., PATIONIC® 1052K, Corbion).

In some aspects, the polymeric compositions can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of the stabilizer (e.g., IRGAFOS® 168, BASF).

### B. Polymeric Composition Properties

The polymeric compositions of the present invention can have a haze lower than the haze of random ethylene polypropylene copolymer, when measured under similar conditions. In some aspects, the polymeric compositions have a haze value of less than 60%, as measured in accordance with ASTM D-1003, at a thickness of about 40 mils.

The polymeric compositions of the present invention can have a crystallization temperature greater than the crystallization temperature of random ethylene polypropylene copolymer, when measured under similar conditions. In some aspects, the polymeric compositions have a crystallization temperature of more than 100° C., as determined by Differential Scanning Calorimetry (DSC) in accordance with ASTM D-3418D.

The polymeric compositions can have any one of, any combination of, or all of the properties mentioned herein.

### C. Methods for Making the Polymeric Compositions

The polymeric compositions of the present invention can be made by various methods known in the art. Non-limiting methods include extrusion, blow-molding, injection-molding, rotational molding, compression molding, thermoforming, or the like. For example, components such as the random ethylene polypropylene copolymer, (optional) acid neutralizer, gamma nucleator, and/or one or more additives can be mixed, such as dry blended, and then melt-blended, such as extruded, to form the polymeric composition. The extruder used can be any type of extruder known in the art. The extrusion can be performed at a temperature high enough to melt the composition, but as low as possible to avoid excessive thermal degradation of the components.

### D. Articles Containing the Polymeric Compositions

The polymeric compositions of the present invention can be comprised in an article of manufacture. In some aspects, the article of manufacture can be an extruded, a blow-molded, an injection-molded, a rotational-molded, a compression-molded and/or thermoformed article. In some particular aspects, the article of manufacture can be an injection molded part or sheet.

Non-limiting examples of articles of manufacture can include: a medical sharps container, tote, bins, pipettes, laboratory ware, food packaging container, food storage container, cooking utensil, plate, cup, cavity tray, drinking cup, measuring cup, strainer, turkey baster, non-food storage container, filing cabinet, cabinet drawer, general storage device, organizer, sweater box, rigid packaging, deli container, deli container lid, dairy container, dairy container lid, personal care product bottle and jar, furniture, furniture component, building material and building container components, film, coating, fiber, bag, adhesive, yarn and fabric blister, clamshell, etc. In these and other uses the polymeric compositions may be combined with other materials, such as particulate materials, including talc, calcium carbonate, wood, and fibers, such as glass or graphite fibers, to form composite materials.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### A. Example 1 (Compositions Containing Metallocene Random Ethylene Polypropylene Copolymer)

Polymeric compositions C-1 to C-7 were made with components as shown in Table 1. Formulations were made using M8623KZ random ethylene polypropylene copolymer (TotalEnergies) as the base resin.

Compositions C-1 to C-7 were formulated with different loadings of a nucleator and had a melt flow rate (MFR) of about 13±0.5 dg/min. The different loadings of the nucleator corresponded to: 0 ppm (C-1, representing a “baseline” M8623KZ copolymer); 200 ppm (C-2); 300 ppm (C-3); 450 ppm (C-4); 600 ppm (C-5); 750 ppm (C-6); and 900 ppm (C-7). As shown in Table 1, a gamma-nucleator (e.g., HPN® 68L) was used as the nucleator, calcium stearate was used as an acid neutralizer, a hindered phenol (e.g., IRGANOX® 1010) was used as an antioxidant, a glycerol ester (e.g., PATIONIC® 1052K) was used as an antistatic/release agent, and a phosphite-based stabilizer (e.g., IRGAFOS® 168) was used as a stabilizer.

Compositions C-1 to C-7 were injection molded into ASTM specimens according to ASTM specifications as injection molded bars at a thickness of 3.2 mm (0.125 in), and characterizations for mechanical properties were determined by evaluating their behavior when subjected to a force or load during testing. The mechanical properties of the injection molded bars comprising Compositions C-1 to C-7 are provided in Table 2.

Compositions C-1 to C-7 were injection molded as stepchips according to ASTM specifications at four different thicknesses (20, 40, 60, and 80 mil, where a mil is a measurement that equals one-thousandth of an inch, or 0.001 inch). The optical properties of injection molded stepchips comprising Compositions C-1 to C-7 at the different thicknesses are provided in Table 3.

Compositions C-1 to C-7 were injection molded into ASTM specimens according to ASTM specifications. The melt flow was substantially consistent for each of Compositions C-1 to C-7, with an MFR of about 13±0.5 dg/min. The thermal properties of Compositions C-1 to C-7 are provided in Table 4.

TABLE 1
Polymeric Compositions (C-1 to C-7)

| Component | Polymeric Composition | | | | | | |
|---|---|---|---|---|---|---|---|
| (wt. %) | C-1 | C-2 | C-3 | C-4 | C-5 | C-6 | C-7 |
| M8623KZ Base Resin¹ | 99.72 | 99.70 | 99.69 | 99.675 | 99.66 | 99.645 | 99.63 |
| IRGANOX ® 1010² | 0.07 | 0.07 | 0.07 | 0.07 | 0.07 | 0.07 | 0.07 |
| PATIONIC ® 1052K³ | 0.1 | 0.1 | 0.1 | 0.1 | 0.1 | 0.1 | 0.1 |
| IRGAFOS ® 168⁴ | 0.07 | 0.07 | 0.07 | 0.07 | 0.07 | 0.07 | 0.07 |
| Calcium stearate | 0.04 | 0.04 | 0.04 | 0.04 | 0.04 | 0.04 | 0.04 |
| HPN ® 68L⁵ | 0 | 0.02 | 0.03 | 0.045 | 0.06 | 0.075 | 0.09 |

¹M8623KZ Base Resin is commercially available from TotalEnergies (Houston, Texas, USA). It is a metallocene ethylene-polypropylene random copolymer. It has a melt flow of 12 g/10 min (D-1238 Condition “L”), a tensile strength of 4,500 psi (ASTM D-638), an elongation of 9% (ASTM D-638), a tensile modulus of 190,000 psi (ASTM D-638), a flexural modulus of 190,000 psi (ASTM D-790), an IZOD Impact at 73° F. Notched of 1.0 ft.-lbs/in. (ASTM D-256A) and Unnotched no break (ASTM D-256A), a haze (0.04 inch plaque) of 8% (D-1003), a melting point of 271° F. (DSC), a heat deflection of 171° F. at 66 psi (ASTM D-648), and a density of 0.900 (D-1505).
²IRGANOX ® 1010 is commercially available from BASF (Charlotte, North Carolina, USA). It is a sterically hindered primary phenolic antioxidant. It has a chemical formula of pentaerythritol tetrakis(3-(3,5-di-tert-butyl-4-hydroxyphenyl)propionate).
³PATIONIC ® 1052K is commercially available from Chempoint (Bellevue, Washington, USA). It is a glycerol monostearate additive for polyolefin compositions.
⁴IRGAFOS ® 168 is commercially available from BASF (Charlotte, North Carolina, USA). It is a processing stabilizer for polyolefin compositions. It has a chemical formula of tris(2,4-di-tert.-butylphenyl) phosphite.
⁵HPN ® 68L is commercially available as Hyperform ® HPN ® 68L from Milliken & Company (Spartanburg, South Carolina, USA). It is a gamma nucleating agent. It includes disodium; (1R,2R,3S,4S)-bicyclo[2.2.1]heptane-2,3-dicarboxylate.

TABLE 2
Mechanical Properties (C-1 to C-7)

| | Polymeric Composition | | | | | | |
|---|---|---|---|---|---|---|---|
| Property | C-1 | C-2 | C-3 | C-4 | C-5 | C-6 | C-7 |
| Tensile | 179,065 | 190,404 | 188,088 | 189,884 | 189,069 | 187,567 | 189,522 |
| Modulus | | | | | | | |
| (Psi) | | | | | | | |
| Flexural | 147,743 | 175,161 | 175,478 | 172,085 | 176,796 | 176,704 | 177,313 |
| Modulus | | | | | | | |
| (Psi) | | | | | | | |
| (chord 4- | | | | | | | |
| 8N) | | | | | | | |
| Izod - | 0.52 | 0.84 | 0.83 | 0.83 | 0.87 | 0.82 | 0.82 |
| Notched | | | | | | | |
| (ft-lb/in) | | | | | | | |
| Izod - | Complete | Complete | Complete | Complete | Complete | Complete | Complete |
| Break type | | | | | | | |

As can be seen from Table 2, the addition of 200 ppm of HPN® 68L resulted in increased stiffness (flexural modulus) properties and impact (Izod) properties relative to the polymeric composition corresponding to the “baseline” M8623KZ copolymer (i.e., Composition C-1). However, adding more than 200 ppm of HPN® 68L did not significantly increase the stiffness and impact properties.

TABLE 3
Optical Properties (C-1 to C-7)

| | | Polymeric Composition | | | | | | |
|---|---|---|---|---|---|---|---|---|
| Property | | C-1 | C-2 | C-3 | C-4 | C-5 | C-6 | C-7 |
| Haze (%) | 20 mil | 38.3 | 21.1 | 20.3 | 18.1 | 16.3 | 15.3 | 15.0 |
| | 40 mil | 56.8 | 39.7 | 37.1 | 35.8 | 31.5 | 30.5 | 30.1 |
| | 60 mil | 72.8 | 54.9 | 51.7 | 49.7 | 44.3 | 43.3 | 42.8 |
| | 80 mil | 84.7 | 63.8 | 61.6 | 61.0 | 55.2 | 53.3 | 52.3 |
| Gloss (%) | Gloss, 45 | 66.2 | 70.6 | 72.4 | 74.1 | 70.8 | 83.9 | 84 |

As can be seen from Table 3, the addition of HPN® 68L resulted in reduced haze relative to the polymeric composition corresponding to the “baseline” M8623KZ copolymer (i.e., Composition C-1). Additionally, as can be seen from Table 3, the addition of HPN® 68L resulted in increased gloss relative to the polymeric composition corresponding to the “baseline” M8623KZ copolymer (i.e., Composition C-1).

TABLE 4
Thermal Properties (C-1 to C-7)

| | Polymeric Composition | | | | | | |
|---|---|---|---|---|---|---|---|
| Property | C-1 | C-2 | C-3 | C-4 | C-5 | C-6 | C-7 |
| MFR (dg/min) | 12.6 | 13 | 12.9 | 12.8 | 12.7 | 12.9 | 13.2 |
| Crystallization | 100.8 | 110.1 | 110.1 | 110.2 | 110.3 | 110.3 | 110.6 |
| Temperature (° C.) | | | | | | | |
| Shrinkage Isotropy | 0.026 | 0.116 | 0.128 | 0.142 | 0.167 | 0.156 | 0.162 |

As can be seen from Table 4, the addition of 200 ppm of HPN® 68L resulted in increased crystallization temperature (by about 10° C.) relative to the polymeric composition corresponding to the “baseline” M8623KZ copolymer (i.e., Composition C-1). However, adding more than 200 ppm of HPN® 68L did not significantly increase the crystallization temperature. Additionally, as can be seen from Table 4, the addition of HPN® 68L negatively affects isotropic shrinkage relative to the polymeric composition corresponding to the “baseline” M8623KZ copolymer (i.e., Composition C-1).

### B. Example 2 (Compositions Containing Ziegler-Natta Random Ethylene Polypropylene Copolymer)

Polymeric compositions C-8 to C-14 were made with components as shown in Table 5. Formulations were made using 6573 random ethylene polypropylene copolymer (Fina) as the base fluff.

Compositions C-8 to C-14 were formulated with different loadings of a nucleator and had an MFR of about 9±0.5 dg/min. The different loadings of the nucleator corresponded to: 0 ppm (C-8, representing a “baseline” 6573 copolymer); 200 ppm (C-9); 300 ppm (C-10); 450 ppm (C-11); 600 ppm (C-12); 750 ppm (C-13); and 900 ppm (C-14). As shown in Table 5, a gamma-nucleator (e.g., HPN® 68L) was used as the nucleator, calcium stearate was used as an acid neutralizer, a hindered phenol (e.g., IRGANOX® 1010) was used as an antioxidant, a glycerol ester (e.g., PATIONIC® 1052K) was used as an antistatic/release agent, and a phosphite-based stabilizer (e.g., IRGAFOS® 168) was used as a stabilizer.

Compositions C-8 to C-14 were injection molded into ASTM specimens according to ASTM specifications as injection molded bars at a thickness of 3.2 mm (0.125 in), and characterizations for mechanical properties were determined by evaluating their behavior when subjected to a force or load during testing. The mechanical properties of the injection molded bars comprising polymeric compositions C-8 to C-14 are provided in Table 6.

Polymeric compositions C-8 to C-14 were injection molded as stepchips according to ASTM specifications at four different thicknesses (20, 40, 60, and 80 mil, where a mil is a measurement that equals one-thousandth of an inch, or 0.001 inch). The optical properties of injection molded stepchips comprising polymeric compositions C-8 to C-14 at the different thicknesses are provided in Table 7.

The melt flow was substantially consistent for each of Compositions C-8 to C-14, with an MFR of about 9±0.5 dg/min. The thermal properties of polymeric compositions C-8 to C-14 are provided in Table 8.

TABLE 5
Polymeric Compositions (C-8 to C-14)

| Component | Polymeric Composition | | | | | | |
|---|---|---|---|---|---|---|---|
| (wt. %) | C-8 | C-9 | C-10 | C-11 | C-12 | C-13 | C-14 |
| 6573 Base Resin¹ | 99.72 | 99.70 | 99.69 | 99.675 | 99.66 | 99.645 | 99.63 |
| IRGANOX ® 1010² | 0.07 | 0.07 | 0.07 | 0.07 | 0.07 | 0.07 | 0.07 |
| PATIONIC ® 1052K³ | 0.1 | 0.1 | 0.1 | 0.1 | 0.1 | 0.1 | 0.1 |
| IRGAFOS ® 168⁴ | 0.07 | 0.07 | 0.07 | 0.07 | 0.07 | 0.07 | 0.07 |
| Calcium stearate | 0.04 | 0.04 | 0.04 | 0.04 | 0.04 | 0.04 | 0.04 |
| HPN ® 68L⁵ | 0 | 0.02 | 0.03 | 0.045 | 0.06 | 0.075 | 0.09 |

¹6573 Base Resin is commercially available from TotalEnergies (Houston, Texas, USA). It is a Ziegler Natta ethylene-polypropylene random copolymer. It has a melt flow of 8 g/10 min (D-1238), an elongation at break of 500% (ASTM D-882), a tensile strength at break of 48.3 MPa (ASTM D882), a melting point of 148° C. (DSC), a haze value of 2.0% (ASTM D1003), and a density of 0.900 (D-1505).
²IRGANOX ® 1010 is commercially available from BASF (Charlotte, North Carolina, USA). It is a sterically hindered primary phenolic antioxidant. It has a chemical formula of pentaerythritol tetrakis(3-(3,5-di-tert-butyl-4-hydroxyphenyl)propionate).
³PATIONIC ® 1052K is commercially available from Chempoint (Bellevue, Washington, USA). It is a glycerol monostearate additive for polyolefin compositions.
⁴IRGAFOS ® 168 is commercially available from BASF (Charlotte, North Carolina, USA). It is a processing stabilizer for polyolefin compositions. It has a chemical formula of tris(2,4-di-tert.-butylphenyl) phosphite.
⁵HPN ® 68L is commercially available as Hyperform ® HPN ® 68L from Milliken & Company (Spartanburg, South Carolina, USA). It is a gamma nucleating agent. It includes disodium; (1R,2R,3S,4S)-bicyclo[2.2.1]heptane-2,3-dicarboxylate.

TABLE 6
Mechanical Properties (C-8 to C-14)

| | Polymeric Composition | | | | | | |
|---|---|---|---|---|---|---|---|
| Property | C-8 | C-9 | C-10 | C-11 | C-12 | C-13 | C-14 |
| Tensile | 190,081 | 171,293 | 188,143 | 189,918 | 187,850 | 189,431 | 189,691 |
| Modulus | | | | | | | |
| (Psi) | | | | | | | |
| Flexural | 143,296 | 178,877 | 178,523 | 175,697 | 175,815 | 179,292 | 177,036 |
| Modulus | | | | | | | |
| (Psi) | | | | | | | |
| (chord 4- | | | | | | | |
| 8N) | | | | | | | |
| Izod - | 0.72 | 1.12 | 1.15 | 1.14 | 1.11 | 1.16 | 1.15 |
| Notched | | | | | | | |
| (ft-lb/in) | | | | | | | |
| Izod - | Complete | Complete | Complete | Complete | Complete | Complete | Complete |
| Break type | | | | | | | |

As can be seen from Table 6, the addition of 200 ppm of HPN® 68L resulted in increased stiffness (flexural modulus) properties and impact (Izod) properties relative to the polymeric composition corresponding to the “baseline” 6573 copolymer (i.e., Composition C-8). However, adding more than 200 ppm of HPN® 68L did not significantly increase the stiffness and impact properties.

TABLE 7
Optical Properties (C-8 to C-14)

| | | Polymeric Composition | | | | | | |
|---|---|---|---|---|---|---|---|---|
| Property | | C-8 | C-9 | C-10 | C-11 | C-12 | C-13 | C-14 |
| Haze (%) | 20 mil | 18.2 | 12.8 | 11.6 | 10.2 | 9.9 | 10.2 | 9.6 |
| | 40 mil | 42.2 | 39.4 | 36.3 | 31.4 | 28.3 | 26.2 | 24.6 |
| | 60 mil | 70.0 | 60.6 | 56.3 | 45.8 | 42.6 | 39.9 | 37.5 |
| | 80 mil | 81.2 | 63.9 | 62.4 | 52.2 | 51.5 | 45.4 | 44.6 |
| Gloss (%) | Gloss, 45 | 51.6 | 52 | 51.4 | 51.8 | 52.2 | 52.6 | 51.5 |

As can be seen from Table 7, the addition of HPN® 68L resulted in reduced haze relative to the polymeric composition corresponding to the “baseline” 6573 copolymer (i.e., Composition C-8). Interestingly, unlike the metallocene RCP (see results in Table 3 above), gloss does not appear to be affected by the addition of HPN® 68L relative to the polymeric composition corresponding to the “baseline” 6573 copolymer (i.e., Composition C-8).

TABLE 8
Thermal Properties (C-8 to C-14)

| | Polymeric Composition | | | | | | |
|---|---|---|---|---|---|---|---|
| Property | C-8 | C-9 | C-10 | C-11 | C-12 | C-13 | C-14 |
| MFR (dg/min) | 9 | 8.9 | 9 | 8.8 | 9.5 | 9 | 9.1 |
| Crystallization | 105.5 | 118.5 | 119.1 | 119.8 | 120.1 | 120.5 | 120.8 |
| Temperature (° C.) | | | | | | | |
| Shrinkage Isotropy | 0.07 | 0.08 | 0.09 | 0.08 | 0.07 | 0.10 | 0.04 |

As can be seen from Table 8, the addition of 200 ppm of HPN® 68L resulted in increased crystallization temperature (by about 13° C.) relative to the polymeric composition corresponding to the “baseline” 6573 copolymer (i.e., Composition C-8) and stayed relatively constant above 200 ppm of HPN® 68L. Interestingly, unlike the metallocene RCP (see results in Table 4 above), the addition of HPN® 68L did not negatively affect isotropic shrinkage relative to the polymeric composition corresponding to the “baseline” 6573 copolymer (i.e., Composition C-8).

Unlike most polypropylene (PP) nucleators, Hyperform® HPN® 68L (Milliken) is an example of a gamma-nucleator. Various benefits cited by Milliken for HPN® 68L include isotropic shrinkage, reduced warpage, and very fast nucleation speeds. Milliken touts the nucleator as one designed for use with PP homopolymers. Its efficacy in random copolymers is less understood, hence the inventors explored this topic. One question explored by the inventors in the present disclosure was how well HPN® 68L would perform in high ethylene metallocene RCPs versus ZN RCPs, in terms of crystallization temperature, mechanical properties, and optical properties. With respect to mechanical properties such as flexural and tensile moduli, the inventors performed various testing as described herein because it was unclear from literature if there might be synergies between the nucleator, rheology and fountain flow during mold filling. Another question explored by the inventors in the present disclosure was whether it was possible to achieve “ultimate isotropic shrinkage” by combining HPN® 68L with metallocene versus what is achieved in ZN PP.

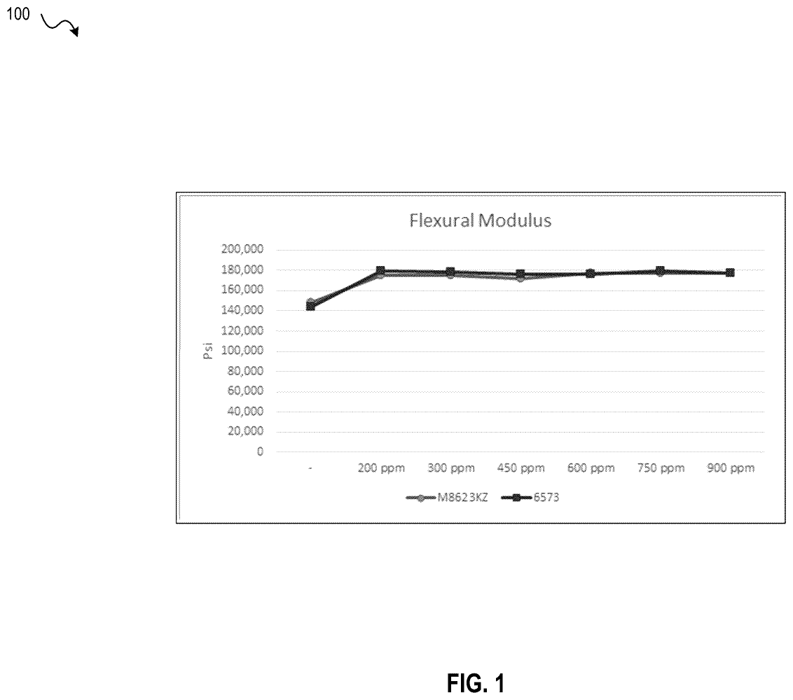

In terms of mechanical properties, as depicted in FIG. 1, the inventors have determined that the tested 200 ppm loading of HPN® 68L appears to represent a target loading for the exemplary mRCP and exemplary ZN RCP tested. However, the inventors have noted that this target loading could be revised lower with further study, as 200 ppm was the lowest loading of the exemplary gamma-nucleator that was tested. That is, in terms of mechanical properties, the target loading may be less than 200 ppm (i.e., between 0 ppm and 200 ppm).

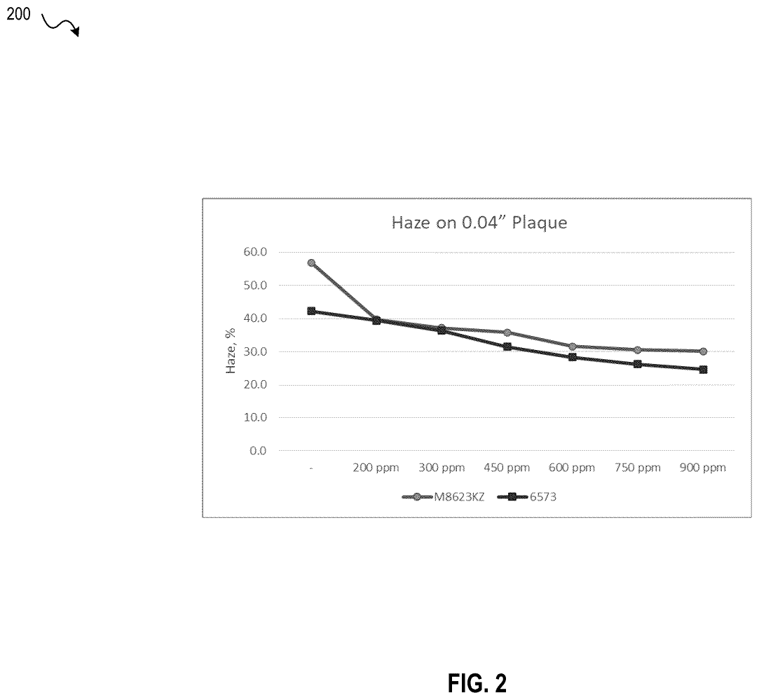

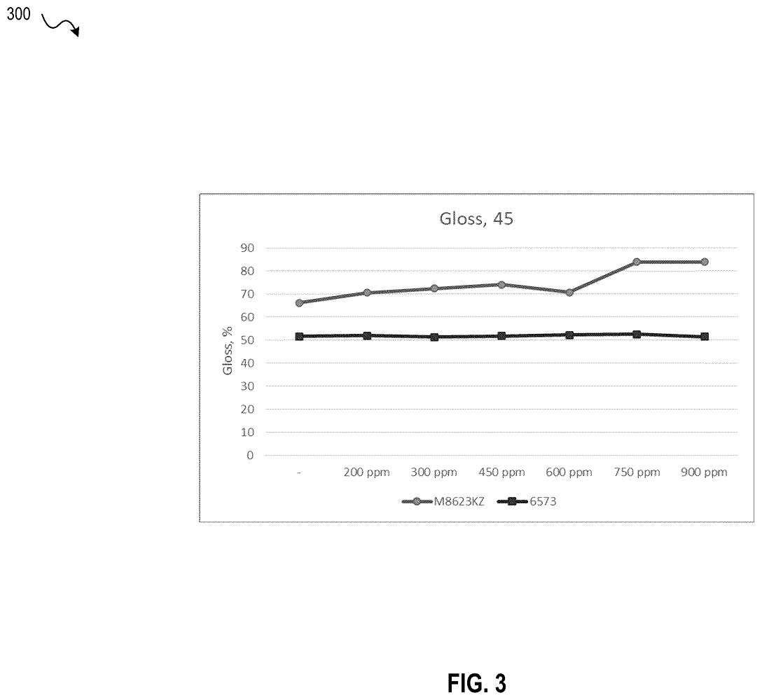

In terms of optical properties, as depicted in FIG. 2, the inventors have determined that the tested 600 ppm loading of HPN® 68L appears to represent a target loading for the exemplary mRCP tested, and the tested 450 ppm loading appears to represent a target loading for the exemplary ZN RCP tested (to obtain a similar haze value, for a thickness on plaque of about 40 mils). Further, in terms of optical properties, FIG. 3 illustrates the interesting finding by the inventors that gloss does not seem to be affected by the addition of HPN® 68L to the exemplary ZN RCP.

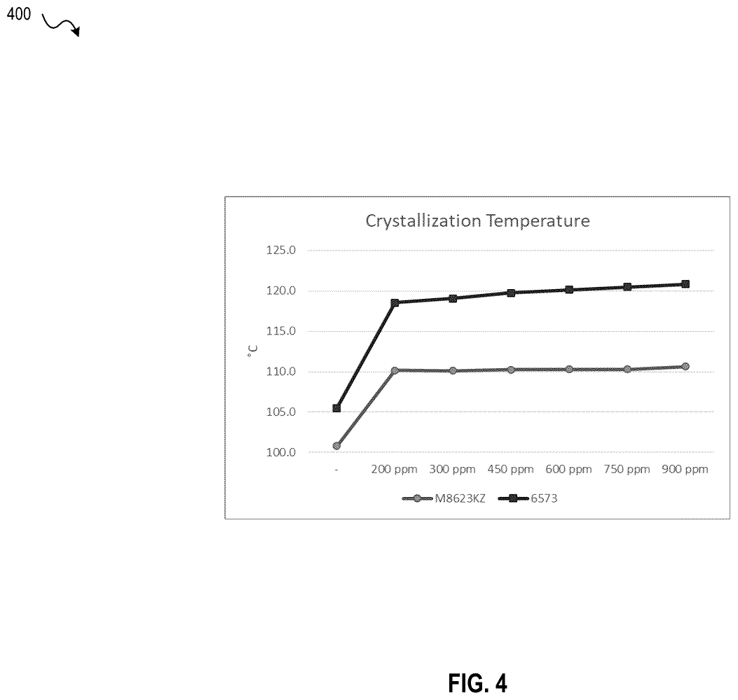

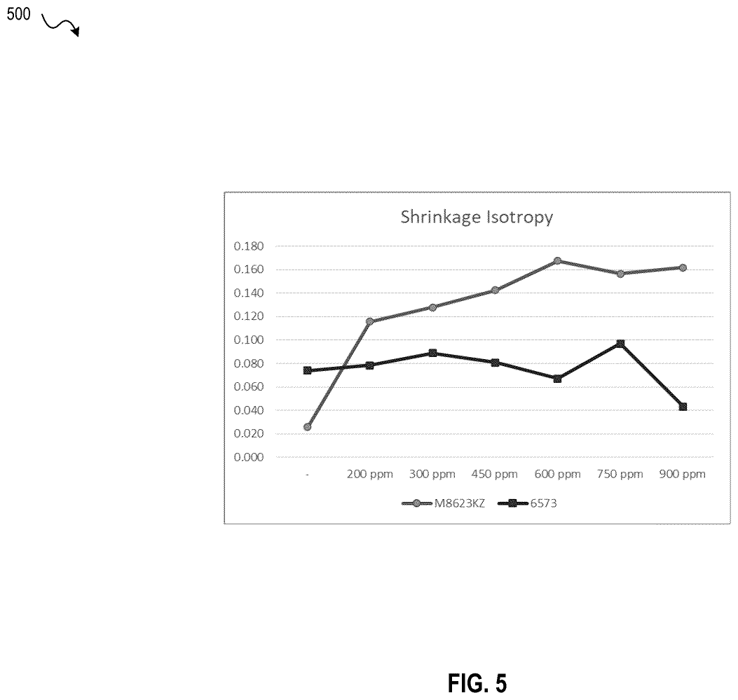

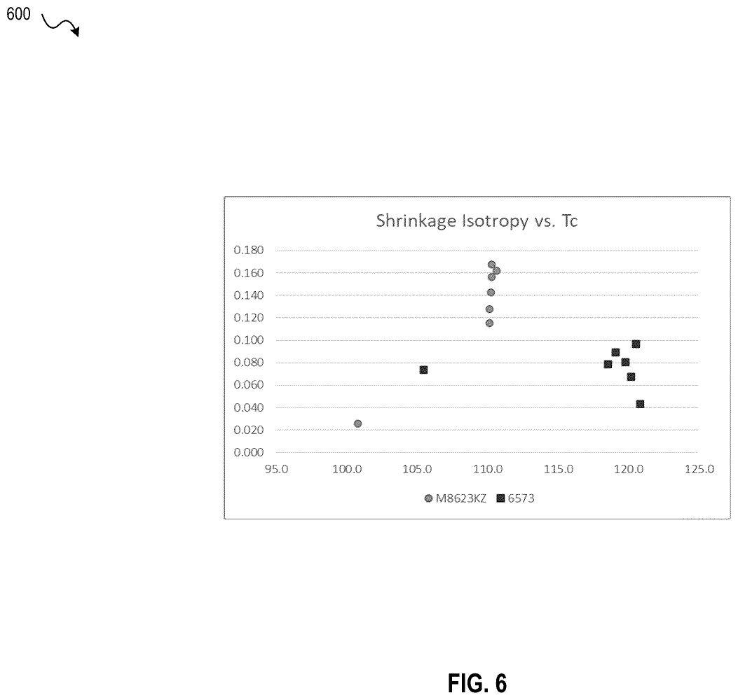

In terms of thermal properties, as depicted in FIG. 4, the inventors have determined that the exemplary ZN RCP tested gives higher crystallization temperature values and better performance at lower HPN® 68L loadings in comparison to the exemplary mRCP tested. With respect to isotropic shrinkage, as depicted in FIG. 5, the inventors have determined that the tested 600 ppm loading of HPN® 68L appears to represent a target loading for the exemplary mRCP tested that no loading of HPN® 68L appears to be superior for the exemplary ZN RCP tested. To provide additional context with respect to both shrinkage isotropy and crystallization temperature, FIG. 6 is designed to illustrate comparative results for the exemplary mRCP and ZN RCP tested in terms of shrinkage isotropy versus crystallization temperature.

Literature from Milliken related to HPN® 68L loadings indicates that there is an inflection point at about 500 to 600 ppm. However, as depicted in FIG. 4, the results of the experimentation performed by the inventors shows the surprising and novel finding that this inflection point is around 250 ppm for both the exemplary RCPs tested. This may translate into at least a 50 percent loading/price reduction. As such, these results could be leveraged to help save additive costs because the experimental results depicted in FIG. 4 illustrate that the “elbow” transition region in peak crystallization temperature that Milliken cites at around 500 to 600 ppm is markedly different from what one would expect from Milliken's literature.

The experimental results in the present disclosure revealed a first unexpected result. RCPs show superior response to HPN-68L at low concentrations of <500 ppm. Milliken teaches that at the HPN-68L is an additive designed for use with polypropylene homopolymers. This use also implies use in impact copolymers where the matrix is a homopolymer. In this use, concentration needs to be at ˜600 ppm or higher before the crystallization temperature (Tc) becomes less dependent on HPN-68L concentration. This relationship between Tc and concentration is illustrated in their literature, with Tc significantly decreasing at concentrations <600 ppm. Its efficacy in random copolymers is less understood, hence we explored this topic. Surprisingly, it was determined that HPN-68L's use could be extended to random copolymers and yield a superior response. Formulations in both Ziegler-Natta and metallocene random copolymers surprisingly resulted in no clear transition region at ˜600 ppm. In both cases, at concentrations as low as 200 ppm, HPN-68L displayed high nucleation efficacy (i.e., no dramatic decrease in HPN-68L performance).

The experimental results in the present disclosure revealed a second unexpected result. Metallocene RCP Tc is less dependent/nearly invariant to HPN-68L concentration >200 ppm. Specifically, a linear fit between Tc and concentration yields a slope approaching 0 (similar to Milliken's example with NaBz illustrated in their literature). This result has practical utility. It means that the polymer will deliver the same crystallization response within normal lot-to-lot HPN-68L concentration. That improves consistency in polymer conversion processes, which helps ensure maximum yields in finished goods. Potential markets where such consistency is highly valued include medical, labware and personal care packaging. A second practical result is that it allows a lower concentration of nucleator to be used. This attribute is important for formulation optimization, maximizing additive efficiency and cutting cost.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A polymeric composition comprising:
at least 98 wt. % of a random ethylene polypropylene copolymer, wherein the random ethylene polypropylene copolymer comprises 0.5 wt. % to 12 wt. % of ethylene units and 88 wt. % to 99.5 wt. % of propylene units based on the total weight of the copolymer;
0 wt. % to 1.0 wt. % of an acid neutralizer; and
0.005 wt. % to 1.0 wt. % of a gamma nucleator,
wherein the polymeric composition has a haze value of less than 60%, as measured in accordance with ASTM D-1003, at a thickness of about 40 mils, and
wherein the polymeric composition has a crystallization temperature of more than 100° C., as measured by Differential Scanning Calorimetry.

2. The polymeric composition of claim 1, wherein the polymeric composition comprises 0.01 wt. % to 1.0 wt. % of the acid neutralizer.

3. The polymeric composition of claim 1, wherein the random ethylene polypropylene copolymer is a random-heterophasic copolymer.

4. The polymeric composition of claim 1, wherein the random ethylene polypropylene copolymer is a Ziegler-Natta random ethylene polypropylene copolymer.

5. The polymeric composition of claim 1, wherein the random ethylene polypropylene copolymer is a metallocene random ethylene polypropylene copolymer.

6. The polymeric composition of claim 5, wherein the polymeric composition comprises:
at least 98 wt. % of the random ethylene polypropylene copolymer, wherein the random ethylene polypropylene copolymer comprises 1.5 wt. % to 5 wt. % of ethylene units and 95 wt. % to 98.5 wt. % of propylene units based on the total weight of the copolymer; and
0.03 wt. % to 1 wt. % of the acid neutralizer.

7. The polymeric composition of claim 1, wherein the gamma nucleator comprises disodium; (1R,2R,3S,4S)-bicyclo[2.2.1]heptane-2,3-dicarboxylate.

8. The polymeric composition of claim 1, wherein the polymeric composition includes less than 950 parts per million (ppm) of the gamma nucleator.

9. The polymeric composition of claim 1, wherein the polymeric composition includes less than 500 parts per million (ppm) of the gamma nucleator.

10. The polymeric composition of claim 1, wherein the polymeric composition includes less than 250 parts per million (ppm) of the gamma nucleator.

11. The polymeric composition of claim 1, wherein the acid neutralizer is a metal stearate comprising calcium stearate, zinc stearate, potassium stearate, sodium stearate, lithium stearate, aluminum stearate, magnesium stearate, manganese stearate, cobalt stearate, cerium stearate, copper stearate, ferric stearate, nickel stearate, or any combinations thereof.

12. The polymeric composition of claim 1, further comprising one or more additives selected from an antioxidant, a stabilizer, a peroxide, a slip agent, an antistatic additive, an FR additive, a light stabilizer, a flow modifier, a process aid, an anti-block agent, an optical brightener, or any combinations thereof.

13. A polymeric composition comprising:
at least 98 wt. % of a random ethylene polypropylene copolymer, wherein the random ethylene polypropylene copolymer comprises 0.5 wt. % to 12 wt. % of ethylene units and 88 wt. % to 99.5 wt. % of propylene units based on the total weight of the copolymer;
0 wt. % to 1.0 wt. % of an acid neutralizer; and
0.005 wt. % to 1.0 wt. % of a gamma nucleator,
wherein the random ethylene polypropylene copolymer is a Ziegler-Natta random ethylene polypropylene copolymer or a metallocene random ethylene polypropylene copolymer,
wherein the polymeric composition has a haze value of less than 60%, as measured in accordance with ASTM D-1003, at a thickness of about 40 mils, and
wherein the polymeric composition has a crystallization temperature of more than 100° C. as measured by Differential Scanning Calorimetry.

14. The polymeric composition of claim 13, wherein the polymeric composition comprises 0.01 wt. % to 1.0 wt. % of the acid neutralizer.

15. The polymeric composition of claim 13, wherein the gamma nucleator comprises disodium; (1R,2R,3S,4S)-bicyclo[2.2.1]heptane-2,3-dicarboxylate.

16. The polymeric composition of claim 13, wherein the polymeric composition includes less than 950 parts per million (ppm) of the gamma nucleator, less than 500 ppm of the gamma nucleator, or less than 250 ppm of the gamma nucleator.

17. An article of manufacture comprising a polymeric composition, the polymeric composition comprising:
at least 98 wt. % of a random ethylene polypropylene copolymer, wherein the random ethylene polypropylene copolymer comprises 0.5 wt. % to 12 wt. % of ethylene units and 88 wt. % to 99.5 wt. % of propylene units based on the total weight of the copolymer;
0 wt. % to 1.0 wt. % of an acid neutralizer; and
0.005 wt. % to 1.0 wt. % of a gamma nucleator,
wherein the polymeric composition has a haze value of less than 60%, as measured in accordance with ASTM D-1003, at a thickness of about 40 mils, and
wherein the polymeric composition has a crystallization temperature of more than 100° C. as measured by Differential Scanning Calorimetry.

18. The article of manufacture of claim 17, wherein the polymeric composition comprises 0.01 wt. % to 1.0 wt. % of the acid neutralizer.

19. The article of manufacture of claim 17, wherein the polymeric composition is a sheet or a film.

20. The article of manufacture of claim 17, wherein the article of manufacture is a medical sharps container, tote, bins, pipettes, laboratory ware, food packaging container, food storage container, cooking utensil, plate, cup, cavity tray, drinking cup, measuring cup, strainer, turkey baster, non-food storage container, filing cabinet, cabinet drawer, general storage device, organizer, sweater box, rigid packaging, deli container, deli container lid, dairy container, dairy container lid, personal care product bottle and jar, furniture, furniture component, building material and building container components, coating, fiber, bag, adhesive, yarn and fabric blister, or clamshell.

21. The article of manufacture of claim 17, wherein the random ethylene polypropylene copolymer of the polymeric composition is a Ziegler-Natta random ethylene polypropylene copolymer or a metallocene random ethylene polypropylene copolymer.

22. The article of manufacture of claim 17, wherein the gamma nucleator of the polymeric composition is disodium; (1R,2R,3S,4S)-bicyclo[2.2.1]heptane-2,3-dicarboxylate.

23. The article of manufacture of claim 17, wherein the polymeric composition includes less than 950 parts per million (ppm) of the gamma nucleator, less than 500 ppm of the gamma nucleator, or less than 250 ppm of the gamma nucleator.
